(19) United States
(12) Patent Application Publication
(10) Pub. No.: US 2022/0090826 A1
(43) Pub. Date: Mar. 24, 2022

(54) SOLAR MODULE, SOLAR MODULE-INTEGRABLE ASSEMBLY AND POWER GENERATION SYSTEM

(71) Applicant: SMA Solar Technology AG, Niestetal (DE)

(72) Inventors: Raimund Thiel, Bad Zwesten (DE); Peter Lahnor, Habichtswald (DE); Simon Butterweck, Helsa (DE)

(21) Appl. No.: 17/540,430

(22) Filed: Dec. 2, 2021

Related U.S. Application Data
(63) Continuation of application No. PCT/EP2020/063275, filed on May 13, 2020.

(30) Foreign Application Priority Data
Jun. 5, 2019 (DE) 10 2019 115 145.7

(51) Int. Cl. F24S 50/20; H04J 3/06; H02S 20/23

(52) U.S. Cl. CPC F24S 50/20; G04R 20/02; H02S 20/23; H04J 3/0638

(57) ABSTRACT

The disclosure relates to a solar module, which includes a plurality of solar cells which are interconnected to generate a direct-voltage power at module terminals, and a receiving unit for receiving an accurate time signal. The solar module further includes a communication unit for the synchronous transmission of the received accurate time signal to an inverter. The inverter is connected to the solar module by means of direct-voltage lines. The disclosure also relates to an assembly that can be integrated into a solar module, and to an energy generation system having a solar module of this type.

### CROSS REFERENCE TO RELATED APPLICATIONS

This application is a continuation of International Patent Application number PCT/EP2020/063275, filed on May 13, 2020, which claims priority to German Patent Application number 10 2019 115 145.7, filed on Jun. 5, 2019, and is hereby incorporated by reference in its entirety.

### FIELD

The disclosure relates to a solar module having a receiving unit and a communication unit for transmitting the received precision time signal to an inverter, and to a power generation system having such a solar module.

### BACKGROUND

With the growing share of decentrally generated, renewable energies in the supply of power, there is an increasing need to influence the distribution of power flows in an energy supply network in order to avoid a local overload of the network. It is known that in inductive grids, a power flow over a grid section is accompanied by a phase shift of the grid voltage, so that a determination of the phase shift allows conclusions to draw about the power load in the grid section.

From patent application DE 10 2017 112 438 A1 it is further known to enable a network subscriber to control a power exchange depending on the relative phase determined at the connection point, in order to work towards a regional load balancing of a network. For this purpose, the network subscriber comprises a receiving unit for receiving a time signal defining a reference time.

### SUMMARY

Solar plants as decentralized energy generators with the measurement technology integrated in the inverter of the solar plant are particularly suitable for monitoring a power flow-related phase shift and for reacting quickly and appropriately to changes in the phase shift. In such a system, it would be obvious to also integrate the receiving unit for the reference time signal into the inverter.

However, this is opposed by the fact that the inverters are often installed at a location where a high-precision reference time signal such as a GPS-based time signal cannot be received. Therefore, it is the task of the present disclosure to ensure a receivability of the high-precision time signal via a suitable configuration for solar installations and to enable a low-effort implementation of the functionality of a monitoring of the phase shift of the grid.

A solar module according to the disclosure comprises a plurality of solar cells interconnected to generate a DC power applied to module terminals, a receiving unit configured to receive a precision time signal and a communication unit for time-synchronous transmission of the received precision time signal to an inverter connected to the solar module via DC lines. By integrating the receiving unit into the solar module, it is ensured that a precision time can be received at any time since the solar module is installed in the open air for its power generation. At the same time, an operating voltage for the receiving unit and the communication unit can be easily generated via the module connections and via the DC lines, respectively, or also from the voltage which is dropped only via a part of the solar cells, so that a supply of these components can be ensured from the DC power.

The communication unit does not transmit position information of the receiving unit extracted from several time signals of different transmitters of the time signals, for example satellites, as is usual with GPS signals. Rather, the high-precision time information itself is transmitted in a time-synchronous manner, that is, transmitted in such a manner that the transmission time of the communication unit has a fixed time relationship with the reception time of the reception unit. In this way, the transmitted time signal provides a high-precision time reference to which events, in particular operating or measurement events of an inverter connected to the DC lines, can be related.

In one embodiment, the communication unit is configured as a radio unit for wireless transmission of the precision time signal to the inverter. This avoids the additional expense of wired communication. The use of common wireless protocols such as Bluetooth is possible without restrictions.

An embodiment of the solar module in which the communication unit is configured as a PLC (Power Line Communication) unit for transmitting the precision time signal via the DC voltage lines already present for power transmission also does not require additional cabling. In this case, the precision time signal can, for example, be capacitively or inductively modulated as a high-frequency signal onto the DC power and is thus transmitted, for example, to an inverter provided for converting the DC power and evaluated there. However, other types of superposition of the DC power with a transmission signal are not to be excluded.

Of course, the transmission of the precision time signal from the solar module to a connected inverter leads to a time shift, but this is insignificant in the context of monitoring a phase shift of the grid, as long as the time shift has a constant value over time.

In a further embodiment of the disclosure, a solar module integrable arrangement comprises a receiving unit configured to receive a precision time signal and a communication unit configured to transmit the received precision time signal to an inverter connected to the solar module via DC lines. The arrangement may be accommodated in a junction box of a solar module, or may have a separate housing in order to be arranged in the vicinity of the module, for example, at the DC voltage lines with which the solar module can be electrically connected to further solar modules. In this way, the solar module-integrable arrangement can be electrically connected to the DC voltage lines, for example, by means of an insulation displacement connection, in order in this way both to have access to a supply voltage and, if appropriate, to be able to transmit the precision time signal. By using insulation displacement technology, it is easily possible, for example, to subsequently supplement an existing solar module or an existing power generation system comprising a solar module with an arrangement according to one embodiment of the disclosure.

In a further embodiment of the disclosure, a power generation system comprises a solar module according to the disclosure, as well as an inverter connected to the solar module, wherein the inverter comprises a device configured to detect a point in time with a fixed phase reference within a voltage curve of a connected grid, for example, a voltage zero crossing, which point in time is related to the precision time signal. In this way, the inverter can assign to each voltage zero crossing a specific instant obtained from the precision time signal.

These individual time points can be aggregated, for example by averaging, to reduce the amount of data and to compensate for variations in the individual time points due to network distortions. In one embodiment, the individual or aggregated time points may then be compared with time points of voltage zero crossings recorded at other points in the grid, in order to detect a phase offset between these points and to be able to monitor it over a longer period of time. To this end, in one embodiment the inverter is advantageously arranged to store and pass on the detected time. The transmission can take place, for example, via a data connection to a portal by means of Internet protocols.

### BRIEF DESCRIPTION OF THE DRAWINGS

In the following, the disclosure is illustrated with the aid of figures, of which

FIG. 1 shows an embodiment of a solar module according to the disclosure and of a solar module-integrable arrangement; and

FIG. 2 shows a power generation system according to the disclosure.

### DETAILED DESCRIPTION

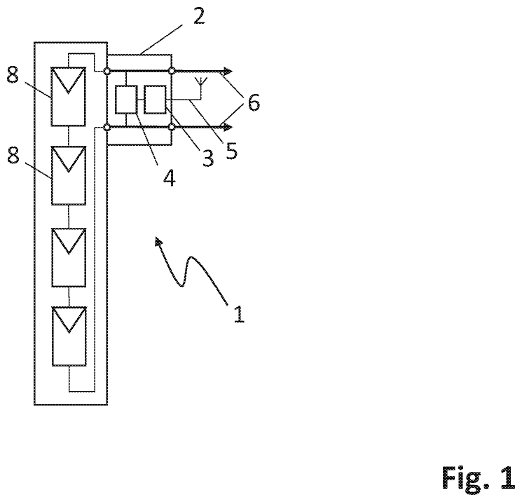

FIG. 1 shows a solar module 1 in which a plurality of solar cells 8 are connected in series to generate DC power. The DC voltage power is led out of the solar module 1 via DC voltage lines 6 in order to connect it to other solar modules or to an inverter. In this case, the DC voltage lines 6 are routed through an arrangement 2, in particular an arrangement integrated in a junction box of the solar module. Within the arrangement 2, a communication unit 4 and a receiving unit 3 for electrical supply are connected to the DC lines 6. Furthermore, an antenna 5 is connected to the receiving unit 3, via which the receiving unit 3 can receive a precision time signal, for example a satellite-based GPS signal, via which a high-precision reference time can be obtained. The reference timing information is transmitted to the communication unit 4 connected to the receiving unit 3. The communication unit 4 is arranged to convert the reference time into a data signal of suitable format and to transmit it to an inverter. In this case, the data signal contains the reference time, and the format as well as the signal frequency are selected such that the receiver can determine a reception time with a sufficient accuracy, for example, an accuracy of less than 10 μs, for example, less than 1 μs. Corresponding formats or usable frequency ranges are known to the skilled person.

Transmission by the communication unit 4 may be by radio, or it may be by modulating the data signal onto the DC power lines 6, for example, inductively or capacitively as a high frequency signal. By demodulation, the data signal can then be obtained and evaluated by the inverter from the DC voltage lines. In the case of transmission by radio, inverters which are not connected to the solar module 1 via the DC voltage lines 6 can also be supplied with the information about the reference time.

It should be noted at this point that time delays occur over the entire transmission path of the precision time signal, which are caused, among other things, by the length of the transmission path, the generation or the evaluation of the signals. However, absolute synchronism with a reference clock is not required for the usability of the reference timing, only relative synchronism. Therefore, constant time delays are not relevant here.

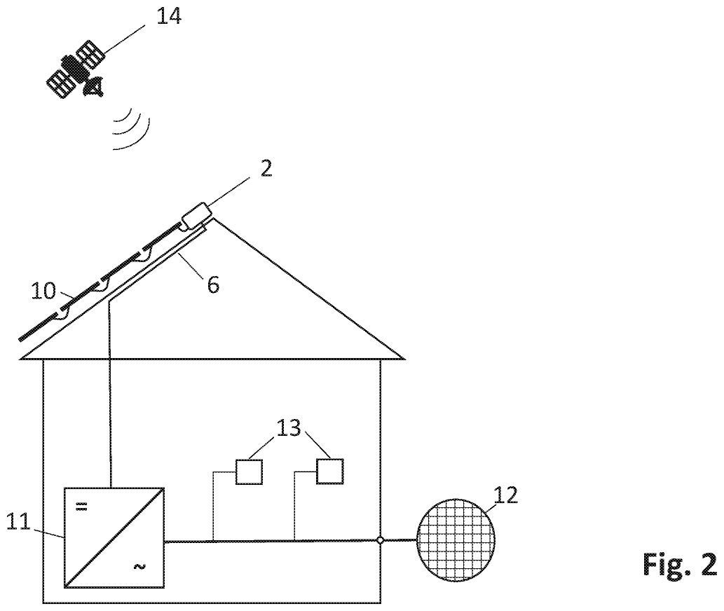

In FIG. 2, a power generation system in the form of a building is shown with a PV system installed on a building roof comprising solar modules 10. The solar modules 10 are connected to each other, to an arrangement 2 and to an inverter 11 via DC power lines 6. The arrangement 2 is shown here as a stand-alone arrangement, but may be integrated into one of the solar modules 10, as shown in connection with the description of FIG. 1. The inverter 11 converts a DC power from the solar modules 10, supplied via the DC lines 6, into an AC power, which it outputs to a connected grid 12, but also to loads 13 within the building, if applicable.

The arrangement 2 is arranged to receive a precision time signal from a time signal generator 14, in this case a satellite, and is located with the roof at a location where the precision time signal from the time signal generator 14 can be received. The received timing signal is alternatively transmitted by the arrangement 2 as a radio signal or as a PLC signal modulated onto the DC power to the inverter 11, which is configured to receive the transmitted signal. The inverter 11 is not able to directly receive the precision time signal from the time signal generator 14 due to its installation location, for example in a basement of the building.

Furthermore, the inverter is configured to detect a point in time with a fixed phase reference within a voltage curve of the connected grid 12, for example, a voltage zero crossing, to relate this point in time to the received time signal and to store it. For this purpose, the inverter may comprise a PLL (phase locked loop) circuit. Instead of a single point in time with a fixed phase reference, a grid frequency or a grid frequency curve with a start or end point in time related to the received time signal can also be determined and stored, so that a notification of a plurality of detected points in time is provided, which increases the accuracy of the detection.

The data stored in this way about times and/or network frequencies or network frequency characteristics can be transmitted to a central evaluation unit for such data at a later time.

Since inverters in any case have a PLL circuit or other suitable circuit for determining a point in time with a fixed phase reference within a voltage waveform of the connected grid 12 for their operation, and regularly also have components for receiving the time signal for other communication purposes, a power generation system according to the disclosure can do without additional components on the inverter side.

The arrangement 2 can also be retrofitted into an existing power generation system. For this purpose, it can be installed in a junction box of an existing solar module and connected to the DC lines. However, it is also conceivable to provide an additional connection unit, for example, a connection unit that is simply clipped over the DC lines by means of an insulation displacement technique, such as described in the publication DE 20 2012 103 480 U1.

1. A solar module comprising:
a plurality of solar cells connected together to generate a DC power applied to module terminals,
a receiving unit configured to receive a precision time signal, and
a communication unit configured to time-synchronously transmit the received precision time signal to an inverter connected to the module terminals of the solar module via DC lines.

2. The solar module according to claim 1, wherein the receiving unit and the communication unit are configured to be supplied power from the DC power generated by one or more of the plurality of solar cells.

3. The solar module according to claim 1, wherein the communication unit comprises a PLC unit configured to transmit the precision time signal to the inverter via the DC lines.

4. The solar module according to claim 1, wherein the communication unit comprises a radio unit configured to transmit the received precision time signal to the inverter via a wireless transmission.

5. The solar module according to claim 1 in combination with an inverter to form a power generation system, the inverter comprising a device configured to detect a point in time with a fixed phase reference within a voltage profile of a connected network, wherein the point in time is related to the precision time signal.

6. The solar module according to claim 5, wherein the inverter is further configured to store and transmit the detected point in time.

7. The solar module according to claim 5, wherein the device is configured to detect a voltage zero crossing as the point in time with a fixed phase reference.

8. A solar module-integrable arrangement, comprising:
a receiving unit configured to receive a precision time signal; and
a communication unit configured to transmit the received precision time signal to an inverter connected to the solar module via DC lines.

9. The solar module-integrable arrangement according to claim 8, wherein the receiving unit and the communication unit are configured to be supplied power from the DC power generated by one or more of the plurality of solar cells.

10. The solar module-integrable arrangement according to claim 8, wherein the communication unit comprises a PLC unit configured to transmit the precision time signal to the inverter via the DC lines.

11. The solar module-integrable arrangement according to claim 8, wherein the communication unit comprises a radio unit configured to transmit the received precision time signal to the inverter via a wireless transmission.

12. A power generation system comprising:
a solar module comprising:
a plurality of solar cells connected together to generate a DC power applied to module terminals,
a receiving unit configured to receive a precision time signal, and
a communication unit,
an inverter connected to the module terminals of the solar module via DC lines,
wherein the communication unit is configured to time-synchronously transmit the received precision time signal to the inverter, and
wherein the inverter is configured to detect a point in time with a fixed phase reference within a voltage profile of a connected grid, wherein the point in time is related to the precision time signal.

13. The power generation system according to claim 12, wherein the inverter is further configured to store and transmit the detected point in time.

14. The power generation system according to claim 12, wherein the inverter is configured to detect a voltage zero crossing of the connected grid as the point in time with a fixed phase reference.
